(19) United States
(12) Patent Application Publication
(10) Pub. No.: US 2022/0164884 A1
(43) Pub. Date: May 26, 2022

(54) METHODS AND SYSTEMS FOR CUSTOMIZING EMERGENCY FUND BUILD UP

(71) Applicant: Huntington Bancshares Incorporated, Columbus, OH (US)

(72) Inventors: Bryan James Carson, New Albany, OH (US); Mark Richard Rhoades, Columbus, OH (US)

(21) Appl. No.: 17/402,741

(22) Filed: Aug. 16, 2021

Related U.S. Application Data
(60) Provisional application No. 63/117,844, filed on Nov. 24, 2020.

(51) Int. Cl. G06Q 40/06; G06Q 40/02; G06N 20/00

(52) U.S. Cl. CPC G06Q 40/06; G06N 20/00; G06Q 40/02

(57) ABSTRACT

Methods for customizing an emergency fund account are provided. In one aspect, the method includes monitoring income sources and spending patterns associated with a client account. The method includes processing the monitored income sources and spending patterns to determine an initial fund goal for an emergency fund account associated with the client account The method includes transmitting, to a device associated with the client account, goal options comprising a first option to accept the initial fund goal and a second option to establish a custom fund goal. The method includes creating the emergency fund account based on a selection of one of the goal options. The method includes transmitting, to the device, a selection of deposit options for depositing funds into the emergency fund account based on the selection of one of the goal options. Systems and machine readable media are also provided.

### CROSS-REFERENCE

The present application claims the benefit of priority under 35 U.S.C. § 119 from U.S. Provisional Patent Application Ser. No. 63/117,844 entitled “METHODS AND SYSTEMS FOR CUSTOMIZING EMERGENCY FUND BUILD UP,” filed on Nov. 24, 2020, the disclosure of which is hereby incorporated by reference in its entirety for all purposes.

### TECHNICAL FIELD

The present disclosure generally relates to financial management systems and services, and more specifically relates to methods and systems for customizing emergency fund build up.

### BACKGROUND

People who set aside emergency funds are better prepared to face potential financial hardships due to unexpected circumstances. However, building up such emergency funds may be challenging since it requires discipline, and often, some help may be needed to analyze one's financial picture in order to allocate resources for a better build up. While financial institutions may offer fund accounts that their customers may independently utilize as emergency fund accounts, traditional financial institutions are nevertheless, mostly hands-off or lack offering products that may help customers to build up their emergency funds better.

### BRIEF DESCRIPTION OF DRAWINGS

The disclosure is better understood with reference to the following drawings and description. The elements in the figures are not necessarily to scale, emphasis are instead being placed upon illustrating the principles of the disclosure. Moreover, in the figures, like-referenced numerals may designate to corresponding parts throughout the different views.

FIG. 1 illustrates an example of a computer implemented method of customizing an emergency fund account buildup for a client.

FIG. 2 illustrates an example of a server that customizes an emergency fund account buildup in a communication system.

FIGS. 3A to 3C are example illustrations associated with the example computer implemented method of FIG. 1.

### SUMMARY

According to certain aspects of the disclosure, a computer implemented method for customizing an emergency fund account is provided. The method is executed by at least a processor in a server, at least one code stored in a non-transitory computer-readable medium which causes the server to perform steps. The method includes monitoring income sources and spending patterns associated with a client account. The method includes processing the income sources and the spending patterns that are monitored to determine an initial fund goal for an emergency fund account associated with the client account. The method includes transmitting, to a device associated with the client account, goal options, wherein the goal options comprise a first option to accept the initial fund goal and a second option to establish a custom fund goal having a value different from the initial fund goal. Additional and different types of goal options may also be presented, whether customized or generic to a particular client. The method includes creating in response to receiving feedback associated with the goal options, the emergency fund account based on a selection of one of the goal options. The method includes transmitting, to the device associated with the client account, a selection of deposit options for depositing funds into the emergency fund account based on the selection of one of the goal options. In certain aspects, the amount of funds transferred may be driven by a set saving schedule, which could be customized by the financial institution and/or the client. The amount of the funds transferred may be derived from payday transfers. In other aspects, a determination of the amount of funds in each transfer may be based on using an automated tool that identifies available funds to transfer from the client's bank account into the client's emergency fund account.

According to other aspects of the present disclosure, a non-transitory machine-readable storage medium comprising machine-readable instructions for causing a processor to execute a method is provided. The method includes monitoring income sources and spending patterns associated with a client account. The method includes processing the income sources and the spending patterns that are monitored to determine an initial fund goal for an emergency fund account associated with the client account. The method includes transmitting, to a device associated with the client account, goal options, wherein the goal options comprise a first option to accept the initial fund goal and a second option to establish a custom fund goal having a value different from the initial fund goal. Additional and different types of goal options may also be presented, whether customized or generic to a particular client. The method includes creating in response to receiving feedback associated with the goal options, the emergency fund account based on a selection of one of the goal options. The method includes transmitting, to the device associated with the client account, a selection of deposit options for depositing funds into the emergency fund account based on the selection of one of the goal options.

According to other aspects of the present disclosure, a system is provided. The system includes a memory comprising instructions and a processor configured to execute the instructions which, when executed, cause the processor to monitor income sources and spending patterns associated with a client account. The processor is configured to execute the instructions which, when executed, cause the processor to process the income sources and the spending patterns that are monitored to determine an initial fund goal for an emergency fund account associated with the client account. The processor is configured to execute the instructions which, when executed, cause the processor to transmit, to a device associated with the client account, goal options, wherein the goal options comprise a first option to accept the initial fund goal and a second option to establish a custom fund goal having a value different from the initial fund goal. Additional and different types of fund goal options may be presented, whether customized or specific to a particular client. The processor is configured to execute the instructions which, when executed, cause the processor to create, in response to receiving feedback associated with the goal options, the emergency fund account based on a selection of one of the goal options. The processor is configured to execute the instructions which, when executed, cause the processor to transmit, to the device associated with the client account, a selection of deposit options for depositing funds into the emergency fund account based on the selection of one of the goal options.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### DETAILED DESCRIPTION

For example, a financial product, such as a customized Personal Emergency Fund (PEF) offered by a financial institution where a client has an existing bank account relationship, enables the client to set aside a dynamic fund transfer periodically through targeted financial analysis. The financial product may utilize an algorithm, such as, for example, a machine learning algorithm, to evaluate, over a defined time period, each individual client's income sources and spending patterns, and in some aspects, third party data, to identify a personalized emergency fund goal for that client. In certain aspects, in order to identify the client's emergency fund goal, the algorithm contains a personalized financial analysis, which may include steps of statistically analyzing, over a defined time period for the client, such as, but not limited to, (a) evaluating income sources including both recurring deposits and non-recurring deposits, (b) evaluating spending patterns including recurring expenses, non-recurring expenses and cash withdrawal pattern. The cash withdrawal pattern can include, but is not limited to, analyzing withdrawal frequency, total amount and an average amount over the first defined period, and mining the spending pattern or the cash withdrawal to identify and select discretionary spending or the cash withdrawal for potentially added fund transfer after selective spending or withdrawal elimination or reduction.

Once the personalized emergency fund goal has been identified, there are several ways for the customer to fund the emergency fund account. For example, in certain aspects, a funding tool may be selected to identify discretionary expenses or cash withdrawal patterns that may be eliminated or reduced in order to find or increase a surplus as a determined amount for automatic and periodic transfer from at least one bank account of the client into the emergency fund account. In certain aspects, the funding tool may be automated to identify available funds to transfer from the client's bank account into the client's emergency fund account. The personal emergency fund is therefore, saved up towards a realistic goal based on a realistic financial picture of the client, in order to meet the client's unexpected expenses when needed. Another example is that the client may select from one or more options for periodic transfers that are presented to the client. In another example, a client may specify its own structure for funding the emergency fund account for example by specifying one-time payment(s) or specifying scheduled periodic transfers.

When a client is a new customer at the financial institution or a client has insufficient transaction history for the algorithm to perform the target financial analysis, the algorithm may use third party data to identify the personalized emergency fund goal for the client For example, the algorithm may use data including, but not limited to, the average monthly deposit inflows of tenured clients, demographics, household income data, which, in some examples, may be segmented by certain additional conditions such as, but not limited to, age, to estimate a personalized emergency fund goal for such a client who is a new customer or has insufficient transaction history.

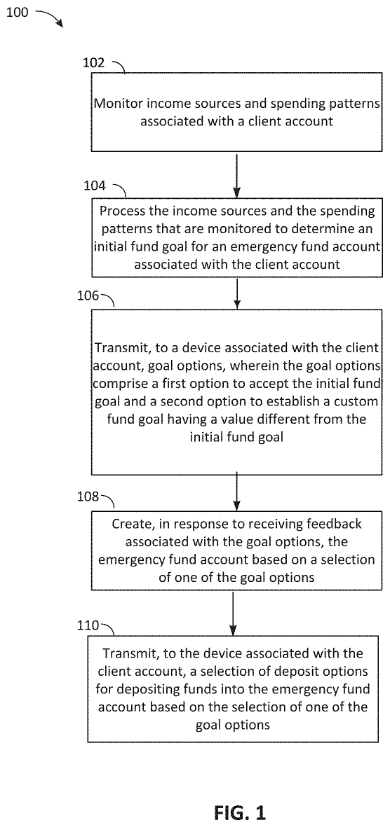

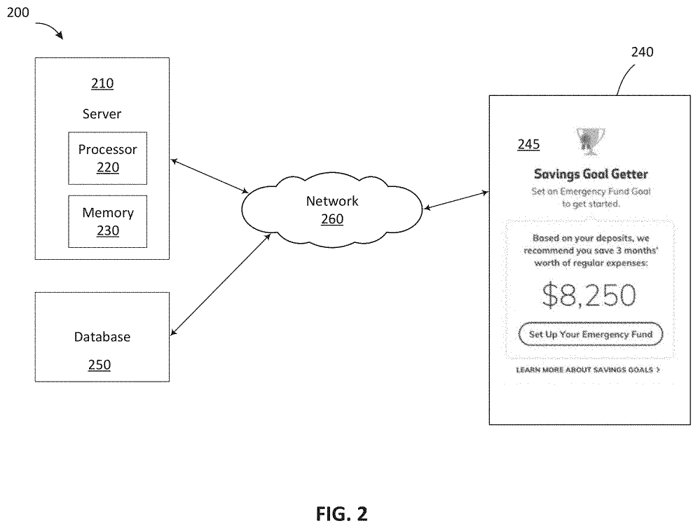

FIG. 1 illustrates an example of a computer implemented method 100 of customizing an emergency fund account buildup for a client. In implementation, the method may be carried out by a communication system 200 illustrated in FIG. 2. The method 100 may be executed by at least a processor 220 in a server 210, at least one code stored in a non-transitory computer-readable medium (i.e., memory 230) which causes the server 210 to perform at least steps 102 to 110 to customize an emergency fund account buildup for a client.

As depicted in step 102, and with reference to FIGS. 1, 2, and 3A-3C, the server 210 monitors income sources 350 and spending patterns 352 associated with a client account at a financial institution. In step 104, the server 210 processes the income sources 350 and spending patterns 352 that are monitored to determine an initial fund goal 354 for an emergency fund account 356 associated with the client. In some aspects, the server 210 uses an algorithm, which may be stored in memory 230 or in the database 250, to process or analyze the income sources 350 and the spending patterns 352 that are monitored for determining the initial fund goal 354 for the emergency fund account 356 based on the client account. In some aspects, using the algorithm to determine the initial fund goal 354 for the emergency fund 356 based on the client account includes at least one of (a) evaluating income sources 350 including both recurring deposits and non-recurring deposits, (b) evaluating spending patterns 352 including recurring expenses, non-recurring expenses and cash withdrawal pattern, which the cash withdrawal pattern may include analyzing withdrawal frequency, total amount and an average amount over the first defined period, and (c) mining during the defined time period, the spending pattern 352 or the cash withdrawal to identify and select discretionary spending or the cash withdrawal for potential added fund transfer after selective spending or withdrawal elimination or reduction. In certain aspects, the monitored income sources 350 and spending patterns 352 may be statistically analyzed or processed over a defined time period (e.g., 3 months to a year). In certain aspects, the algorithm to determine the initial fund goal 354 includes an AI and/or machine learning component for periodically adjusting the initial fund goal 354 based on monitoring and analyzing the income sources 350 and spending patterns 352 associated with the client account.

As shown in step 106, the server 210 transmits goal options 358 to a terminal device 240 (shown in FIG. 2) associated with the client account and based on the initial fund goal 354. The goal options 358 are displayed on the terminal device 240. In certain aspects, the goal options 358 include goal options to, such as, but not limited to, accept the initial fund goal 354, save a predetermined portion of the initial fund goal 354 and establish a customized fund goal having a value different from the initial fund goal 354. It should be understood that other goal options well-known in the industry are also within the scope of the disclosure.

In step 108, in response to receiving feedback associated with the goal options 358, the server 210 creates the emergency fund account 356 based on the selection of one of the goal options 358. For example, if the option to accept the initial fund goal 354, the server 210 creates the emergency fund account 356 and tracks the progress towards reaching the initial fund goal 354.

As depicted in step 110, the server 210 transmits a selection of deposit options 360 to the terminal device 240 for display. The selection of deposit options 360 includes deposit options for depositing funds into the emergency fund account 356 such as, but not limited to, setting an automatic savings schedule, selecting a funds transfer tool that analyzes spending and expenses to automatically determine an amount, and customizing an amount. In should be understood that other deposit options well-known in the industry are also within the scope of the disclosure.

In certain aspects, based on the training and the statistical analyzing, the algorithm may set an initial goal with an adjustable target amount for the automatic and periodic transferring of the determined amount over a defined target time period, from the at least one bank account into the emergency fund account, wherein the determined amount for an automatic transfer in a next transfer period may be dynamically adjusted according to an updated personalized financial analysis of the income and spending pattern of the client for the next transfer period.

In certain aspects, the user interface 245 of the terminal device 240 of the client may view an updated progress of the adjustable target amount in the emergency fund account towards the initial goal. The transfer period may be weekly, biweekly, semi-monthly or monthly, which may synchronize with a pay period of the client through an employer deposit. In an example, the defined time period may be at least two (bank) statement cycles, wherein the defined target time period may be at least 90 days or more. In another example, the algorithm may also use a shorter time period (i.e., less than 90 days) to perform a personalized financial analysis of the client's income and spending pattern to open an emergency fund account for the client.

In certain aspects, the server 210 may update and notify the client through the user interface 245 of the terminal device 340. For example, the server 210 can update and notify the client through the user interface 245 of the terminal device 340 of at least a total balance progress of the adjustable target amount in the emergency fund account towards the initial goal. Notifications may be sent in various forms, including email, text and via online to the client's online account. Notifications may be sent on some certain frequency or based on client account activity (e.g., emergency fund deposit activity) or other triggering events.

FIG. 2 illustrates an example of a screenshot of the user interface 245 of the terminal device 240 of the client which displays a message, sent from the server 210 through a network 260, for establishing an emergency fund. In certain aspects, a machine learning algorithm may be trained to learn spending habit fluctuations, including on-going recurring expenses, such as one or more of: rent, mortgage payment, vehicle loan payment, utility bills, phone bills, cable subscription, student loans, insurance premium, taxes, membership dues, monthly public transportation expenses, maintenance prescription, lessons, consumer credit card payments, investment contributions, personal savings debits, etc. The spending habit fluctuations learning is being used to train the machine learning algorithm to perform a personalized financial analysis of the ongoing income and spending pattern of the client in order to recommend an increase or a decrease of a next period transfer to the emergency fund account. Likewise, the machine learning algorithm may also be trained to learn on-going fluctuations of non-recurring expenses, such as one or more of: entertainment expenses, dining, food, gas, on-line purchases, medical expenses, traveling expenses, repairs, clothing, family activities, gifts, etc., to train the machine learning algorithm to perform the personalized financial analysis of the ongoing income and spending pattern of the client to recommend an increase or a decrease of a next period transfer to the emergency fund account.

In certain aspects, funding the emergency fund account 356 can include determining an amount of funds in each transfer from the at least one bank account of the client, into two portions, namely, both a fixed amount and a variable amount. More specifically, the fixed amount may include a minimum surplus between the income sources and the spending pattern after the statistical analysis over the defined period, wherein the variable amount may include the identified and selected elimination or reduction of the discretionary spending or the cash withdrawal, after the mining of the spending pattern or the cash withdrawal. In addition, the variable amount further may include contributions from rounding up changes to a next higher dollar through debit card purchases.

In an example, the algorithm may also be trained to perform a comparative financial analysis of recurring and non-recurring spending of previous time periods. The client may receive information in a form of notification messages pushed from the financial institution that may help the client to seek for ways to reduce or eliminate certain recurring or non-recurring expenses, such as refinancing a loan with lower monthly payment or transferring balance to a lower interest rate credit card.

For example, the notification messages pushed by the financial institution or in partnership with third party marketers may include cost saving promotions offerings or life style improvement tips that may further increase surpluses towards reaching the initial goal. In an example, the cost saving promotions offerings may include offerings of lower interest rate financing or refinancing or lower interest rate credit card offers. In an example, the life style improvement tips may include information or recommendations to subscribe generic brands prescription, benefits of healthy eating habits and physical activities to lower medical cost, thrift stores advertisements, and tips on lowering energy cost (e.g., insulation, using LED lights, energy efficient appliances, smart thermostat to automatically control to turn on/off heating, cooling, or light sensor to control lighting, off-peak energy savings, combined trips planning, etc.) to reduce both recurring and non-recurring expenses.

In an example, the algorithm may determine an amount of funds in each transfer from the at least one bank account of the client to include both a fixed amount and a variable amount. For example, the fixed amount portion may be directly computed as a minimum surplus between the income sources and the spending pattern after the statistical analysis over the defined period. An average of the total income and an average of the total spending may be one way to calculate such minimum surplus. Other methods of calculating the minimum surplus may be used. The variable amount portion may include the identified and selected elimination or reduction of the discretionary spending or the cash withdrawal, after the mining of the spending pattern or the cash withdrawal.

In another example, the variable amount may also include contributions from rounding up changes to a next higher dollar amount through debit card purchases. For example, the client may have used a debit card to purchase a cup of coffee which costs $3.18, by rounding up to the next nearest dollar, the client's account may be debited with $4, with $0.82 change being transferred to the emergency fund account as part of the contribution to the variable amount portion during the pending transfer period.

Yet in another example, to maximize a deposit balance of the emergency fund account to reach or exceed the target goal, the method may include configuring the emergency fund account to be designated to receive an automatic deposit of a portion of tax refund from federal or state government.

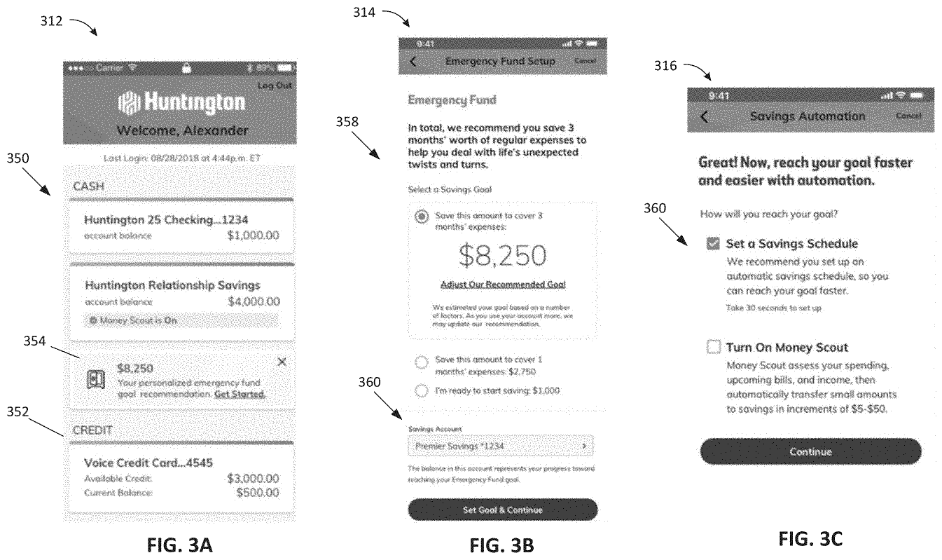

FIGS. 3A to 3C illustrate a series of screenshots, which may be displayed on a user interface of a terminal device according to the example computer implemented method of FIG. 1.

FIG. 3A illustrates a screenshot 312 of the initial fund goal 354 displayed on the terminal device 340. The client will be able to obverse the initial fund goal 354 and select to receive further information for establishing the emergency fund account 360. The screenshot 312 depicts a checking account and saving account as exemplarily income sources 350 although other income sources are well within the scope of the disclosure. The screenshot 312 depicts a credit card account as exemplarily spending patterns 352 although other spending patterns are well within the scope of the disclosure.

FIG. 3B illustrates a screenshot 314 displaying the goal options 358, which the client may select to establish the emergency fund account 360. For example, the goal options 358 include goal options to accept the initial fund goal 354, save a predetermined portion of the initial fund goal 354, establish a customized fund goal having a value different from the initial fund goal 354. The client can select one of the goal options 358 and continue to establish the emergency fund account 360 based on that selection.

FIG. 3C illustrates a screenshot 316 displaying the selection of deposit options 360 for reaching the set goal of the emergency fund. For example, the selection of deposit options 360 includes deposit options to set an automatic savings schedule or select a funds transfer tool that analyzes spending and expenses to automatically determine a deposit amount. In certain aspects, the funds transfer tool may include a machine learning algorithm which may be trained to analyze the client's income sources and spending pattern and to mine the spending pattern or withdrawal pattern to increase a transfer amount for faster build up. Another fund transfer tool may include pay day transfer and recurring transfer. Other financial analysis and fund transfer applications may be used also.

Other variations that may applied include allowing the user the option to customize the emergency fund goal, allowing a user to lower the goal to make it more achievable. Additional features may allow for recognitions to be communicated to the user to help reward meeting certain goals or to help motivate the user to continue to meet their goal. A comparison tool may be included that allows users to access information and data or other comparisons that show how a user's savings compare to other individuals. Criteria may be shared with the user to explain how the comparison was performed and the types of accounts that the comparison included. In connection with the savings goal being achieved, the user could be offered the opportunity to redirect funds to start paying loans or other lines of credit.

Various aspects of the disclosure have been described above. While the present invention has been described with reference to certain aspects, it will be understood by those skilled in the art that various changes may be made and equivalents may be substituted without departing from the scope of the present invention, such as reordering of the sequence of steps in the method disclosed. In addition, many modifications may be made to adapt a particular situation or material to the teachings of the present invention without departing from its scope. Accordingly, various claimed subject matter have been described herein and by the appended claims without limiting the scope of the claimed subject matter.

What is claimed is:

1. A computer implemented method for customizing an emergency fund account, comprising executing by at least a processor in a server, at least one code stored in a non-transitory computer-readable medium which causes the server to perform steps, comprising:
monitoring income sources and spending patterns associated with a client account;
processing the income sources and the spending patterns that are monitored to determine an initial fund goal for an emergency fund account associated with the client account;
transmitting, to a device associated with the client account, goal options, wherein the goal options comprise a first option to accept the initial fund goal and a second option to establish a custom fund goal having a value different from the initial fund goal;
creating, in response to receiving feedback associated with the goal options, the emergency fund account based on a selection of one of the goal options; and
transmitting, to the device associated with the client account, a selection of deposit options for depositing funds into the emergency fund account based on the selection of one of the goal options.

2. The computer implemented method of claim 1, wherein processing the income sources and the spending patterns that are monitored is based on using an algorithm to determine the initial fund goal for the emergency fund based on the client account.

3. The computer implemented method of claim 2, wherein using the algorithm to determine the initial goal for the emergency fund comprises at least one of
(a) evaluating the income sources comprising both recurring deposits and non-recurring deposits, and
(b) evaluating the spending patterns comprising recurring expenses, non-recurring expenses, and cash withdrawal pattern.

4. The computer implemented method of claim 3, wherein the recurring expenses comprise one or more of: rent, mortgage payment, vehicle loan payment, utility bills, phone bills, cable subscription, student loans, insurance premium, taxes, membership dues, monthly public transportation expenses, maintenance prescription, lessons, consumer credit card payments, investment contributions, personal savings debits.

5. The computer implemented method of claim 3, wherein the non-recurring expenses comprise one or more of: entertainment expenses, dining, food, gas, on-line purchases, medical expenses, traveling expenses, repairs, clothing, family activities, gifts.

6. The computer implemented method of claim 1, further comprising:
transferring, based on receiving feedback associated with the selection of deposit options, a determined amount from the client account into the emergency fund account over a defined target time period.

7. The computer implemented method of claim 6, wherein the determined amount is dynamically adjusted according to periodic processing of the income sources and the spending patterns that are monitored.

8. The computer implemented method of claim 7, further comprising:
transmitting, to the device associated with the client account, the determined amount that is dynamically adjusted for display.

9. A non-transitory computer-readable medium which stores at least one code, when executed by at least a processor in a computer, causes the computer to customize an emergency fund account by performing steps, comprising:
monitoring income sources and spending patterns associated with a client account;
processing the income sources and the spending patterns that are monitored to determine an initial fund goal for an emergency fund account associated with the client account;
transmitting, to a device associated with the client account, goal options, wherein the goal options comprise a first option to accept the initial fund goal and a second option to establish a custom fund goal having a value different from the initial fund goal;
creating, in response to receiving feedback associated with the goal options, the emergency fund account based on a selection of one of the goal options; and
transmitting, to the device associated with the client account, a selection of deposit options for depositing funds into the emergency fund account based on the selection of one of the goal options.

10. The non-transitory computer-readable medium of claim 9, wherein processing the income sources and the spending patterns that are monitored is based on using an algorithm to determine the initial fund goal for the emergency fund based on the client account.

11. The non-transitory computer-readable medium of claim 10, wherein using the algorithm to determine the initial goal for the emergency fund comprises at least one of
(a) evaluating the income sources comprising both recurring deposits and non-recurring deposits, and
(b) evaluating the spending patterns comprising recurring expenses, non-recurring expenses, and cash withdrawal pattern.

12. The non-transitory computer-readable medium of claim 11, wherein the recurring expenses comprise one or more of: rent, mortgage payment, vehicle loan payment, utility bills, phone bills, cable subscription, student loans, insurance premium, taxes, membership dues, monthly public transportation expenses, maintenance prescription, lessons, consumer credit card payments, investment contributions, and personal savings debits.

13. The non-transitory computer-readable medium of claim 11, wherein the non-recurring expenses comprise one or more of: entertainment expenses, dining, food, gas, on-line purchases, medical expenses, traveling expenses, repairs, clothing, family activities, and gifts.

14. The non-transitory computer-readable medium of claim 9, further comprising:
transferring, based on receiving feedback associated with the selection of deposit options, a determined amount from the client account into the emergency fund account over a defined target time period.

15. The computer implemented method of claim 14, wherein the determined amount is dynamically adjusted according to periodic processing of the income sources and the spending patterns that are monitored.

16. The computer implemented method of claim 15, further comprising:
transmitting, to the device associated with the client account, the determined amount that is dynamically adjusted for display.

17. A system for customizing an emergency fund account, comprising:
a memory comprising instructions; and
a processor configured to execute the instructions which, when executed, cause the processor to:
monitor income sources and spending patterns associated with a client account;
process the income sources and the spending patterns that are monitored to determine an initial fund goal for an emergency fund account associated with the client account;
transmit, to a device associated with the client account, of goal options, wherein the goal options comprise a first option to accept the initial fund goal and a second option to establish a custom fund goal having a value different from the initial fund goal;
create, in response to receiving feedback associated with the goal options, the emergency fund account based on a selection of one of the goal options; and
transmit, to the device associated with the client account, a selection of deposit options for depositing funds into the emergency fund account based on the selection of one of the goal options.

18. The system of claim 17, wherein processing the income sources and the spending patterns that are monitored is based on using an algorithm to determine the initial fund goal for the emergency fund based on the client account.

19. The system of claim 18, wherein using the algorithm to determine the initial goal for the emergency fund comprises at least one of
(a) evaluating the income sources comprising both recurring deposits and non-recurring deposits, and
(b) evaluating the spending patterns comprising recurring expenses, non-recurring expenses, and cash withdrawal pattern.

20. The system of claim 17, wherein the processor is configured to execute the instructions which, when executed, cause the processor to:
transfer, based on receiving feedback associated with the selection of deposit options, a determined amount from the client account into the emergency fund account over a defined target time period.
